(19) United States
(12) Patent Application Publication
(10) Pub. No.: US 2026/0196142 A1
(43) Pub. Date: Jul. 9, 2026

(54) ENSURING GENUINE LEARNING EXPERIENCE IN VIRTUAL REALITY EDUCATIONAL SESSION

(71) Applicant: International Business Machines Corporation, Armonk, NY (US)

(72) Inventors: Sarbajit Kumar Rakshit, KOLKATA (IN); Natalie Brooks Powell, Bolingbrook, IL (US); Santosh Rajashekar, Bangalore (IN); Selvi John, Bangalore (IN)

(73) Assignee: International Business Machines Corporation, Armonk, NY (US)

(21) Appl. No.: 19/010,743

(22) Filed: Jan. 6, 2025

(51) Int. Cl. G09B 5/06; G06F 21/32; G06Q 30/04

(52) U.S. Cl. CPC G09B 5/065; G06F 21/32; G06Q 30/04

(57) ABSTRACT

An embodiment activates at least one instructor avatar in a virtual reality education session. From the session, a sampling is captured, the sampling being a pattern of an action of the IA in the session, or a sample of content being presented in the session. The sampling from the session is analyzed to determine whether the sampling corresponds to a valid human instructor assigned to the session. From the analysis, a detection is made that the IA has been compromised in the session. The IA is ejected from the session while maintaining the continuity of the session. The IA is replaced in the session with a replacement IA such that the replacement IA continues a planned lesson in the session.

### BACKGROUND

The present invention relates generally to managing virtual reality sessions. More particularly, the present invention relates to a method, system, and computer program for ensuring genuine learning experience in a virtual reality education session.

A key benefit of Virtual Reality (VR) in education lies in its ability to provide immersive learning experiences. VR allows students to explore and interact with subjects in ways that are not possible with traditional methods. It inspires creativity, enhances understanding of complex concepts, improves memory retention, and fosters cultural competence by exposing students to diverse perspectives and experiences. Additionally, VR can improve student outcomes and engagement, making learning more enjoyable and effective.

A VR session is a period of engagement in the VR environment, where the period begins with initiating a series of VR interactions in the VR environment and ends with a concluding interaction in the VR environment. A VR session may include one or more pauses of no VR interactions, so long as there is a distinct interaction identified as a beginning of the session, and a distinct interaction identified as a concluding interaction. In a VR teaching environment, an interaction initiating a class, such as a teacher/proctor/avatar/system admitting students into a virtual classroom, can be regarded as a VR session initiation. Similarly, a concluding interaction in a teaching environment may be the teacher/proctor/avatar/system ending the class session.

An avatar in a VR environment is a representation of an entity interacting in the VR environment. Generally, but not necessarily, an avatar represents a human or a living being in the VR environment. For example, a teacher provides a learning experience in a VR session via an avatar of the teacher. Similarly, each student participating in the VR classroom is represented by a corresponding avatar.

### SUMMARY

The illustrative embodiments provide for ensuring genuine learning experience in a virtual reality education session. An embodiment includes activating at least one IA in a virtual reality (VR) education session (session). The embodiment further includes capturing, from the session, a sampling, the sampling being one of (i) a pattern of an action of the IA in the session, and (ii) a sample of content being presented in the session). The embodiment further includes analyzing whether the sampling from the session corresponds to a valid human instructor assigned to the session). The embodiment further includes detecting, responsive to the analyzing, that the IA has been compromised in the session). The embodiment further includes ejecting the IA from the session while maintaining a continuity of the session). The embodiment further includes replacing, in the session, the IA with a replacement IA such that the replacement IA continues a planned lesson in the session. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example configuration for ensuring genuine learning experience in a VR education session in accordance with an illustrative embodiment;

FIG. 3A depicts an example virtual teaching environment in accordance with an illustrative embodiment;

FIG. 3B depicts an example situation where a compromised IA is detected in accordance with an illustrative embodiment;

FIG. 4 depicts an example process of ensuring genuine learning experience in a VR education session in accordance with an illustrative embodiment;

FIG. 5 depicts an example process for instructor replacement in accordance with an illustrative embodiment;

FIG. 6 depicts an example process of ensuring genuine learning experience in a VR education session using authentication of an IA in accordance with an illustrative embodiment;

FIG. 7 depicts an example process of ensuring genuine learning experience in a VR education session using authentication of an IA in accordance with an illustrative embodiment;

FIG. 8 depicts an example process of instructor replacement for ensuring genuine learning experience in a VR education session in accordance with an illustrative embodiment; and

FIG. 9 depicts an example process of ensuring genuine learning experience in a VR education session using sequence authentication in accordance with an illustrative embodiment.

### DETAILED DESCRIPTION

A VR session for educational purposes is referred to herein as a VR educational session, or simply as an education session or session, unless expressly distinguished where used. Furthermore, a session is also referred to as a teaching session or a learning session interchangeably—because the same session is a teaching session from the perspective of an IA and a learning session from the perspective of a student avatar. A reference herein to a person—such as a teacher or instructor, or a student, or a hacker, or any person or role in general—is a reference to an avatar in the VR session representing that person and/or executing that role, unless expressly distinguished where used.

The illustrative embodiments recognize that during a VR educational session, if a teacher's VR system is hacked or compromised, then the avatar of the teacher in the VR educational environment can become compromised, potentially leading to incorrect teachings. Thus, a method is needed to create a VR educational environment that ensures genuine learning experience.

A method for ensuring authenticity and continuity of educational sessions in a VR environment according to an embodiment monitors a VR educational session to detect whether the instructor and the instruction in the session are authentic. In one embodiment, the monitoring is continuously performed, i.e., in a nonstop loop throughout the session or a portion thereof. In another embodiment, the monitoring is performed periodically, spontaneously, randomly, or a combination thereof.

One objective of the monitoring is to authenticate the instructor. Authentication of the instructor includes assessing the authenticity of a virtual avatar teacher within the VR educational session by a combination of methods. For example, in one embodiment, verifying the authenticity of the instructor includes verifying the educational content being presented by the virtual avatar teacher - such as via a visual presentation. When the content is authentic, i.e., content that matches the scope of the VR education session, the instructor avatar (IA) is deemed to be authentic. Conversely, when an anomaly is detected in the authentication of the content, the IA is deemed to be compromised, and a replacement action is triggered to replace the IA with a suitable replacement IA.

In another embodiment, the authentication includes verifying the source of the content being delivered by the IA as one or more authenticated educational content providers. When the source is authentic, the IA is deemed to be authentic. Conversely, when an anomaly is detected in the authentication of the source of the content, the IA is deemed to be compromised, and a replacement action is triggered to replace the IA with a suitable replacement IA.

In another embodiment, authenticating the instructor includes validating the spoken content against authentic sources. In one embodiment, authenticating the spoken content follows the same method by authenticating other types of content and content provider, as described above. In another embodiment, validating the spoken content includes validating the voice of the instructor avatar as being the instructor's genuine voice. One embodiment maintains a database of previously recorded speech patterns of the instructor. The embodiment compares a speech snippet or sample from the instructor's spoken content with one or more records in the speech database. A match within a specified tolerance authenticates the IA. Conversely, when an anomaly is detected in the authentication of the speech, the IA is deemed to be compromised, and a replacement action is triggered to replace the IA with a suitable replacement IA.

Another embodiment uses a speech analysis model to compare a speech pattern in the instructor's speech with a previously authenticated speech pattern even if the instructor avatar uses a different voice than the human instructor's actual voice. A speech analysis model is an artificial intelligence (AI) model, such as a large language model implementation of a neural network, of a suitable type that has been trained to recognize patterns - such as inflections, pauses, speed of words spoken per unit of time, cadence of words in a speech sample, tonal quality such as monotonous or exuberant and other tonal qualities, and many other characteristics of speech regardless of the voice used in the speech. When a speech pattern from the active VR educational session matches a previously authenticated speech pattern within a specified tolerance for that human instructor, the instructor avatar is said to be authenticated. Conversely, when an anomaly is detected in the authentication of the speech pattern, the IA is deemed to be compromised, and a replacement action is triggered to replace the IA with a suitable replacement IA.

In another embodiment, the IA is authenticated by authenticating a behavior or an interaction begin performed by the IA. A behavior of a human—and correspondingly of an avatar—can be an act or mannerism performed without the act or mannerism being targeted at any specific human or avatar. An interaction is a type of behavior that is targeted at a human or avatar. Some non-limiting examples of the behaviors and interactions may include a dialogue between the IA and a student avatar, a gesture made by the IA in the course of teaching, and the like. In one embodiment, validating the behavior uses a database of previously recorded patterns of behavior of the instructor. The embodiment compares a sample of behavior—a behavior snippet—from the active education session with one or more records in the behavior patterns database. A match within a specified tolerance authenticates the IA. Conversely, when an anomaly is detected in the authentication of the behavior pattern, the IA is deemed to be compromised, and a replacement action is triggered to replace the IA with a suitable replacement IA.

Another embodiment uses a behavior analysis model to compare a behavior pattern or interaction pattern from the session with a previously authenticated behavior pattern. A behavior analysis model is an AI model of a suitable type that has been trained to recognize behavior patterns—such as hand gestures, walking or pacing, nodding or shaking of the head, body positioning and orientation while speaking, and many other characteristics of behavior regardless of the similarities or dissimilarities between the human instructor and the IA. When a behavior pattern from the active VR educational session matches a previously authenticated behavior pattern within a specified tolerance for that human instructor, the instructor avatar is said to be authenticated. Conversely, when an anomaly is detected in the authentication of the behavior pattern, the IA is deemed to be compromised, and a replacement action is triggered to replace the IA with a suitable replacement IA.

In another embodiment, authenticating the IA includes validating the sequence of activities of the instructor avatar in the session. One embodiment maintains a database of previously recorded sequences of activities of the instructor. The embodiment compares a sequence sample from the instructor's presentation in the session with one or more records in the sequences database. A match within a specified tolerance authenticates the IA. Conversely, when an anomaly is detected in the authentication of the sequence, the IA is deemed to be compromised, and a replacement action is triggered to replace the IA with a suitable replacement IA.

Another embodiment uses a sequence analysis model to compare a sequence used in the instructor's teaching with a previously authenticated sequence even if the instructor avatar uses no preset sequence of activities. A sequence analysis model is an AI model of a suitable type that has been trained to recognize correct sequence of activities given the contents of the subject matter being taught—such as a logical progression of diagrams, equations, or expressions according to the subject matter, conclusions that can be drawn at a specific point in the teaching based on the portion of the subject-matter that has been taught or delivered in the session prior to that time, correctness of the sequence, alignment of the sequence with the material being delivered in the session, relevance of the practical demonstrations being made by the IA with the content being delivered in the session, and many other characteristics of sequence in teaching regardless of any preset sequence in a teaching material being used in the session. When a sequence pattern from the active VR educational session matches a previously authenticated sequence pattern within a specified tolerance for that human instructor, the instructor avatar is said to be authenticated. Conversely, when an anomaly is detected in the authentication of the sequence, the IA is deemed to be compromised, and a replacement action is triggered to replace the IA with a suitable replacement IA.

One embodiment is configured to alert the human instructor about an incorrect sequence. Another embodiment is configured to take actions to address incorrect demonstrations or sequences that persist despite alerts. One such action includes replacing the IA with a replacement IA in the session.

An anomaly in any of the described methods of authentication includes a failure to match a given artifact from the session to a comparable authenticated artifact, whether via a database match or an AI model-based matching. Failure to match occurs when a degree of mismatch is greater than a tolerance specified for the particular artifact.

One embodiment maintains a repository of several instructor avatars, e.g., avatars of several human instructors who are competent to teach a specific class. When a replacement action is triggered, the embodiment selects an IA that is different from the IA that has been compromised but is competent to teach the subject-matter being delivered in the active session. In some cases, a replacement IA is also selected based on the ability and availability of the corresponding human instructor to step in and take over the teaching session immediately. One embodiment may interface with a calendaring system to determine the availability of human instructors who are able and available to take over a session.

An embodiment replaces the compromised IA with the replacement IA in a manner that the continuity of the VR education session is unbroken. For example, in one embodiment, the compromised IA is forced to exit the classroom, and the replacement IA is shown to enter the classroom. In another embodiment, the compromised IA is instantly overlaid and replaced with the replacement IA in the same space and location that was occupied by the compromised IA. The exit or overlaying of the compromised IA forms the exit action of the compromised IA in the session.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

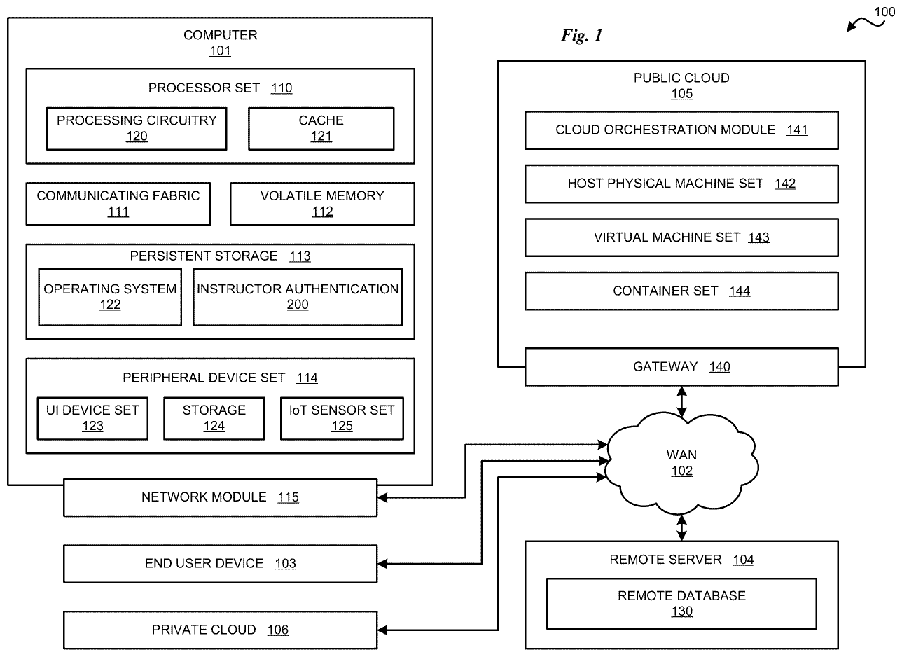

FIG. 1 depicts a block diagram of a computing environment 100. Computing environment 100 contains an example of an environment for the execution of at least some of the computer code involved in performing the inventive methods, such as instructor authentication application 200 that provides authentication of IAs in a VR education session in a manner described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is a collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

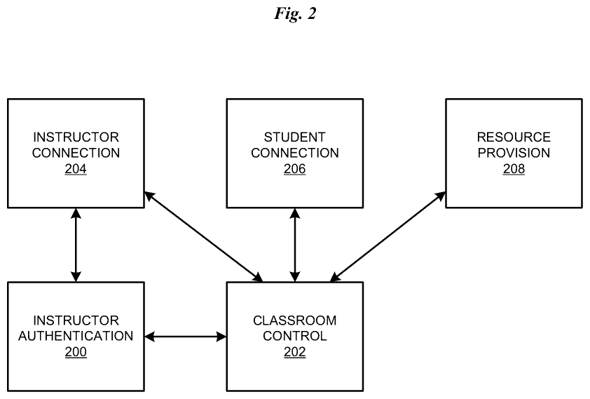

FIG. 2 depicts a block diagram of an example configuration for ensuring genuine learning experience in a VR education session in accordance with an illustrative embodiment. Instructor authentication application 200 is the same as instructor authentication application 200 of FIG. 1. Classroom control 202 is a VR environment infrastructure's interface for managing and controlling a VR education session simulating a classroom environment for learning.

Instructor connection 204 is an interface for a human instructor to interact with the session managed by classroom control 202. Using connection 204, the human instructor interacts with the session as an IA. Student connection 206 is an interface for a human student to interact with the session managed by classroom control 202. Using connection 206, a human student interacts with the session as a student avatar. Typically, one human instructor uses instructor connection 204 and one or more human students utilize student connection 206 in a VR education session. However, the illustrative embodiments contemplate a plurality of human instructors instructing a class in a VR session, a single student attending a class in a VR session, or other combinations.

Resource provision component 208 provides the resources needed in the session to effectuate a learning experience in the session. For example, component 208 may add a whiteboard resource to enable the IA from connection 204 to present visual information in a session. Component 208 may implement, add, remove, or modify any type of virtual resource that may be used in a VR education session managed by classroom control application 202.

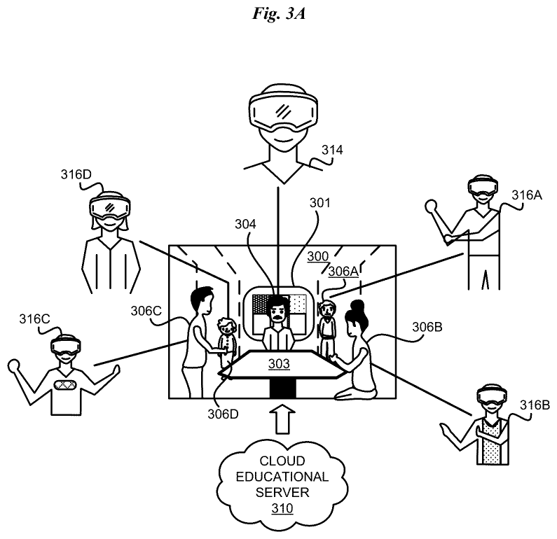

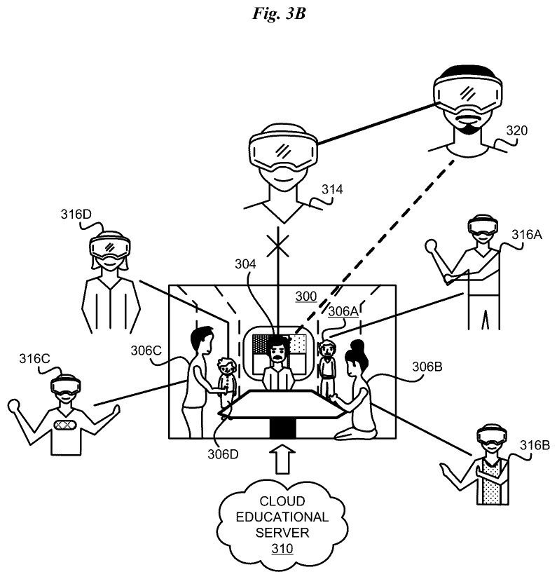

FIG. 3A depicts an example virtual teaching environment in accordance with an illustrative embodiment. Instructor authentication application 200, operates in conjunction with the various applications and components depicted in FIG. 2 on one or more computing hardware. Cloud educational server 310 is an example of such a computing hardware delivering the VR education session experience from a cloud infrastructure.

Instructor authentication application 200 and other components and applications depicted in FIG. 2 operate on server 310 and creates VR education session 300. Session 300 includes IA 304 corresponding to human instructor 314. Similarly, student avatar 306A corresponds to human student 316A, student avatar 306B corresponds to human student 316B, student avatar 306C corresponds to human student 316C, and student avatar 306D corresponds to human student 316D. Some example virtual resources for effectuating teaching/learning in session 300 are also depicted, such as whiteboard 301 and table 303.

FIG. 3B depicts an example situation where a compromised IA is detected in accordance with an illustrative embodiment. Session 300 and all student avatars are as depicted in FIG. 3.

As an example, assume that a hacker or imposter 320 takes over IA 304 which originally corresponded to human instructor 314. Now, in the situation depicted in FIG. 3B, hacker 320 corresponds to IA 304. Instructor authentication in the manner of any of the embodiments described herein detects this takeover and replaces IA 304 with a different IA such that the correspondence of hacker 320 with IA 304 becomes inconsequential to session 300, and a replacement IA (not shown) takes the place of—occupies the space and role of—IA 304 without breaking the continuity of session 300. In effect, Instructor authentication application 200 causes IA 304 to exit session 300 and the replacement IA to continue session 300.

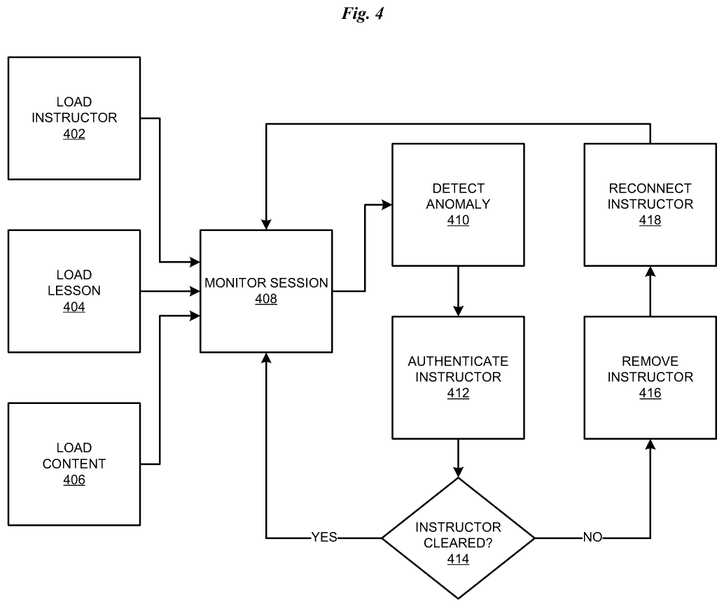

FIG. 4 depicts an example process of ensuring genuine learning experience in a VR education session in accordance with an illustrative embodiment. Instructor authentication application 200 of FIG. 2 loads, or causes classroom control application 202 to load, an instructor avatar (block 402), a lesson or course identification (block 404) that is to be taught or delivered in a session—such as session 300 of FIGS. 3A-B, and the corresponding content (block 406)—such as authenticated content from an authenticated source for lesson 404.

Instructor authentication application 200 monitors session 300 (block 408). Instructor authentication application 200 detects an anomaly with the IA using one or more methods described herein (block 410). Instructor authentication application 200 authenticates the IA (block 412). Instructor authentication application 200 determines whether the IA is successfully authenticated (block 414). If the IA is successfully authenticated (“Yes” path of block 414), Instructor authentication application 200 returns to monitoring the session at block 408.

If the IA authentication fails (“No” path of block 414), Instructor authentication application 200 causes the IA to be removed from the session (block 416) and a new or replacement IA to be connected to the session (block 418). Instructor authentication application 200 returns to monitoring the session at block 408 thereafter until the session ends.

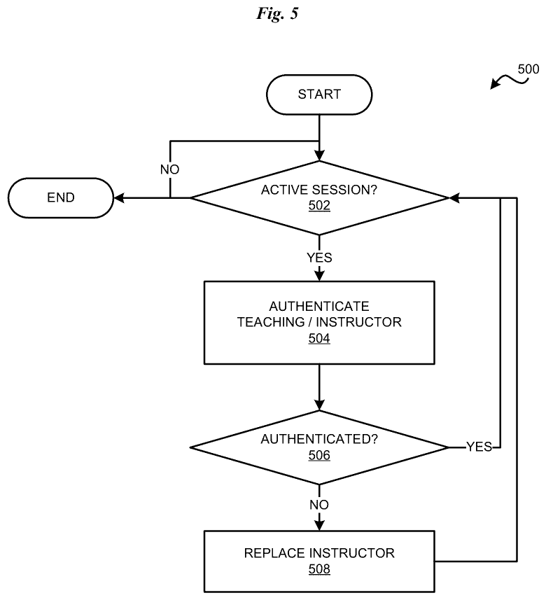

FIG. 5 depicts an example process for instructor replacement in accordance with an illustrative embodiment. Process 500 can be implemented in Instructor authentication application 200 of FIG. 2.

The process determines whether a session is active (block 502). If the session is inactive (“No” path of block 502), i.e., no VR classroom has been initiated, no IA has joined the session, no lesson has been loaded, no content has been loaded, no student has joined the session, or some combination thereof, the process either returns to block 502 for rechecking—e.g., typically while waiting for a session to begin, or ends - e.g., typically after a session has concluded.

If the session is active (“Yes” path of block 502), the process authenticates the teaching occurring in the session and/or the IA teaching the session (block 504). For example, authenticating the content, content provider, or the sequence serves as authenticating the teaching, the instructor, or both, whereas authenticating the speech or the interactions serve to authenticate the instructor.

If the authentication is successful (“Yes” path of block 506), the process returns to block 502. If the authentication fails (“No” path of block 506), the process replaces the instructor in the session (block 508) and returns to block 502.

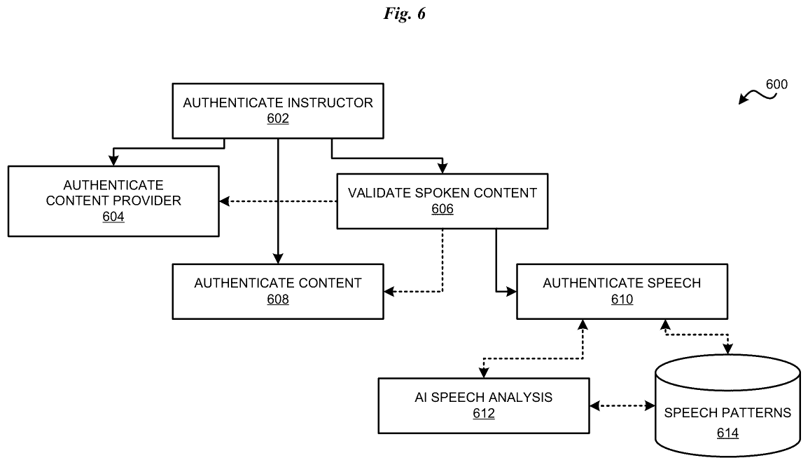

FIG. 6 depicts an example process of ensuring genuine learning experience in a VR education session using authentication of an IA in accordance with an illustrative embodiment. Process 600 begins to authenticate the instructor (block 602), using one, two, or all of the depicted content-related ways, or branches, of authentication. In one branch, the process authenticates a provider or source of the content being delivered by the IA (block 604). Block 604 is performed in a manner described herein. In another branch, the process authenticates, or establishes the validity of, the content being delivered by the IA (block 608). Block 608 is performed in a manner described herein.

In another branch, the process authenticates or validates the spoken content—i.e., the content being delivered using speech (block 606). Block 606 is performed in a manner described herein. Furthermore, the performance of block 606 may, but not necessarily, include a step to authenticate the content using block 608, authenticate the content provider using block 604, or both.

In one implementation of block 606, but not necessarily all implementations of block 606, the process further authenticates the speech itself as belonging to, or corresponding to, the correct or desired human instructor (block 610). To perform block 610, the process may utilize one or both subbranches as follows:

In one subbranch, the speech authentication of block 610 uses a database or repository 614 of speech patterns, which includes patterns of speech corresponding to the desired human instructor for matching in a manner described earlier. In another subbranch, the speech authentication of block 610 uses AI speech analysis model 612. AI speech analysis model 612 can be trained, a priori, using speech patterns from repository 614 in order to perform the speech pattern-based authentication of IA as described earlier.

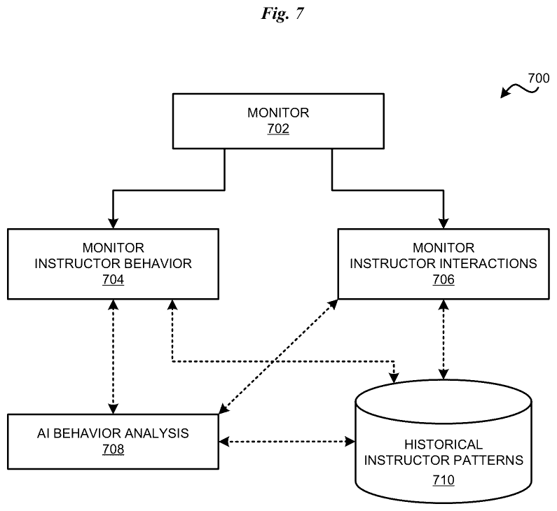

FIG. 7 depicts an example process of ensuring genuine learning experience in a VR education session using authentication of an IA in accordance with an illustrative embodiment. Process 700 begins by monitoring the session, the IA in the session, or both (block 702), using one or all of the depicted behavior-related ways, or branches, of authentication. In one branch, the process monitors and authenticates the behavior of the IA as the IA delivers the content in the session (block 704). Block 704 is performed in a manner described herein. In another branch, the process monitors and authenticates the interactions between the IA and other avatars present in the session (block 706). Block 706 is performed in a manner described herein.

In one implementation of block 704, 706, or both, the process uses repository 710 in which records of past patterns of behavior corresponding to the instructor are maintained. Block 704 uses repository 710 for authentication of a pattern of behavior of the IA by matching the behavior pattern with the historical records in repository 710, as described earlier. Block 706 uses repository 710 for authentication of a pattern of interaction of the IA with other avatars by matching the interaction pattern with the historical records in repository 710, as described earlier.

In another implementation, the process performs the operations of blocks 704, 706, or both, using AI behavior analysis model 708. AI behavior analysis model 708 can be trained, a priori, using behavior patterns from repository 710 in order to perform the behavior pattern-based or interaction pattern-based authentication of IA as described earlier.

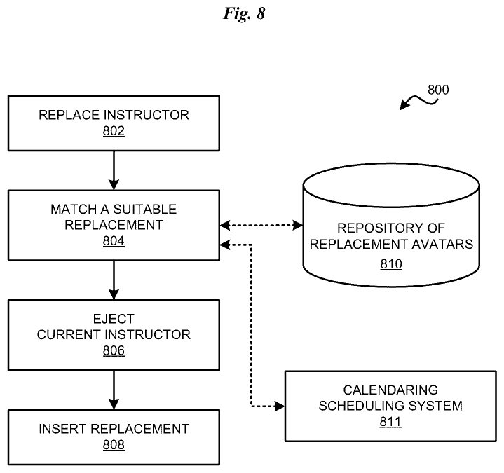

FIG. 8 depicts an example process of instructor replacement for ensuring genuine learning experience in a VR education session in accordance with an illustrative embodiment. Process 800 begins by detecting a need to replace an IA in a session, either due to the IA being compromised or due to an alert not being resolved by the current IA (block 802). The process looks for a replacement IA that is a suitable match for the session, subject-matter of the lesson being delivered in the session, the current point in the lesson being delivered in the session, or a combination thereof (block 804).

To perform block 804, the process matches the IA requirements with the records of replacement instructors in repository 810 to find a suitable replacement. As some nonlimiting examples, the process can match instructor attributes such as the skill, the skill level, the familiarity with the lesson plan, a history of teaching the lesson, a success rate as a replacement instructor for the lesson, or some combination thereof, to find in repository 810 a record that matches at least a desired number and level of attributes. Furthermore, the process at block 804 also optionally interfaces with a calendaring or scheduling system to determine whether the human instructor corresponding to the matching replacement IA is available to take over the teaching from the compromised or nonresponsive IA in the active session.

Responsive to finding a suitable replacement IA whose corresponding human instructor is also available for the session, the process ejects the current IA (block 806). The process inserts the replacement IA in the session in a manner described earlier (block 808).

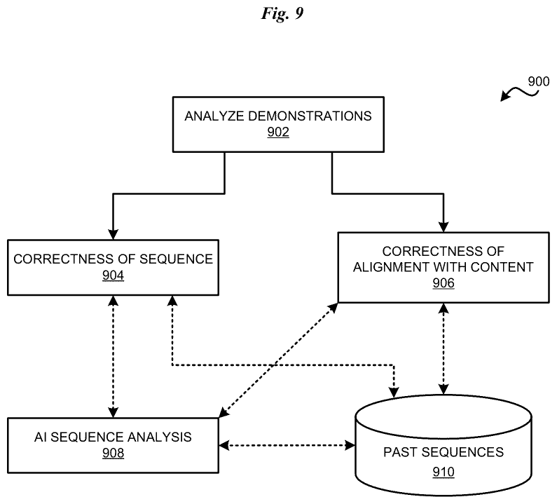

FIG. 9 depicts an example process of ensuring genuine learning experience in a VR education session using sequence authentication in accordance with an illustrative embodiment. Process 900 begins by analyzing a sequence of demonstrations or performances by an IA in a session (block 902). In one branch, the process authenticates the correctness of the sequence as the IA delivers the content in the session (block 904). Block 904 is performed in a manner described herein. In another branch, the process determines the correctness of the alignment of the sequence with the content being presented by the IA (block 906). For example, at block 706, the process determines whether a timing aspect of the demonstration or presentation being made by the IA correctly correlates with a timing aspect of the pace of advancement of the content in the session.

In one implementation of block 904, 906, or both, the process uses repository 910 in which records of past sequences corresponding to the instructor are maintained. Block 904 uses repository 910 for authentication of a pattern in a sequence sample by matching the sequence pattern with the historical records of past sequences in repository 910 for the correctness of the pattern. Block 906 uses repository 910 for authentication of a timing alignment of a sequence sample by matching the sequence timing with the historical sequence records in repository 910 for the timing aspect of the sequence records.

In another implementation, the process performs the operations of blocks 904, 906, or both, using AI sequence analysis model 908. AI sequence analysis model 908 can be trained, a priori, using sequence patterns from repository 910 in order to perform the sequence pattern-based or sequence timing-based authentication of IA as described earlier.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
activating at least one instructor avatar (IA) in a virtual reality (VR) education session (session);
capturing, from the session, a sampling, the sampling being one of (i) a pattern of an action of the IA in the session, and (ii) a sample of content being presented in the session;
analyzing whether the sampling from the session corresponds to a valid human instructor assigned to the session;
detecting, responsive to the analyzing, that the IA has been compromised in the session;
ejecting the IA from the session while maintaining a continuity of the session; and
replacing, in the session, the IA with a replacement IA such that the replacement IA continues a planned lesson in the session.

2. The computer-implemented method of 1, further comprising:
authenticating, as a part of the analyzing, the pattern of the action, wherein the pattern of the action comprises a speech sample being output by the IA into the session;
inputting the speech sample in a pre-trained speech analysis model, wherein the speech analysis model is pre-trained using a repository of speech snippets from a set of human instructors, the set of human instructors comprising the valid human instructor; and
outputting from the speech analysis model a determination that the speech sample fails to correspond to the valid human instructor within a specified tolerance, wherein the determination forms a basis for the detecting.

3. The computer-implemented method of 1, further comprising:
authenticating, as a part of the analyzing, the pattern of the action, wherein the pattern of the action comprises a sample of a behavior being produced by the IA in the session;
inputting the sample of the behavior in a pre-trained behavior analysis model, wherein the behavior analysis model is pre-trained using a repository of behavior snippets from a set of human instructors, the set of human instructors comprising the valid human instructor; and
outputting from the behavior analysis model a determination that the sample of the behavior fails to correspond to the valid human instructor within a specified tolerance, wherein the determination forms a basis for the detecting.

4. The computer-implemented method of 1, further comprising:
authenticating, as a part of the analyzing, the pattern of the action, wherein the pattern of the action comprises a sample of an interaction between the IA and another avatar in the session;
inputting the sample of the interaction in a pre-trained behavior analysis model, wherein the behavior analysis model is pre-trained using a repository of interaction snippets from a set of human instructors, the set of human instructors comprising the valid human instructor; and
outputting from the behavior analysis model a determination that the sample of the interaction fails to correspond to the valid human instructor within a specified tolerance, wherein the determination forms a basis for the detecting.

5. The computer-implemented method of 1, further comprising:
authenticating, as a part of the analyzing, the pattern of the action, wherein the pattern of the action comprises a sample of a sequence of presentations by the IA in the session;
inputting the sample of the sequence of presentations in a pre-trained sequence analysis model, wherein the sequence analysis model is pre-trained using a repository of presentation sequence snippets from a set of human instructors, the set of human instructors comprising the valid human instructor; and
outputting from the sequence analysis model a determination that the sample of the sequence of presentations fails to correspond to the valid human instructor within a specified tolerance, wherein the determination forms a basis for the detecting.

6. The computer-implemented method of 1, further comprising:
authenticating, as a part of the analyzing, the pattern of the action, wherein the pattern of the action comprises a sample of a timing alignment of a sequence of presentations with the content presented by the IA in the session;
inputting the sample of the timing alignment in a pre-trained sequence analysis model, wherein the sequence analysis model is pre-trained using a repository of presentation sequence snippets from a set of human instructors, the set of human instructors comprising the valid human instructor; and
outputting from the sequence analysis model a determination that the sample of the timing alignment fails to correspond to the valid human instructor within a specified tolerance, wherein the determination forms a basis for the detecting.

7. The computer-implemented method of 1, further comprising:
authenticating, as a part of the analyzing, the sample of the content, wherein the sample of the content comprises a teaching material being output by the IA into the session;
determining that the teaching material fails to correspond to a pre-authenticated content within a specified tolerance; and
outputting from the speech analysis model a determination that the sample of the content fails to correspond to the valid human instructor, wherein the determination forms a basis for the detecting.

8. The computer-implemented method of 1, further comprising:
authenticating, as a part of the analyzing, the sample of the content, wherein the sample of the content comprises a teaching material being output by the IA into the session;
determining that a source of the teaching material fails to correspond to a pre-authenticated source of a pre-authenticated content; and
outputting a determination that the sample of the content fails to correspond to the valid human instructor, wherein the determination forms a basis for the detecting.

9. The computer-implemented method of 1, further comprising:
activating a plurality of student avatars in the session, the session further comprising the planned lesson, wherein the IA is configured to deliver a learning experience in the session by representing a presentation of the content by the valid human instructor, and wherein the content corresponds to the planned lesson.

10. A computer program product comprising one or more computer readable storage media, and program instructions collectively stored on the one or more computer readable storage media, the program instructions executable by a processor to cause the processor to perform operations comprising:
activating at least one instructor avatar (IA) in a virtual reality (VR) education session (session);
capturing, from the session, a sampling, the sampling being one of (i) a pattern of an action of the IA in the session, and (ii) a sample of content being presented in the session;
analyzing whether the sampling from the session corresponds to a valid human instructor assigned to the session;
detecting, responsive to the analyzing, that the IA has been compromised in the session;
ejecting the IA from the session while maintaining a continuity of the session; and
replacing, in the session, the IA with a replacement IA such that the replacement IA continues a planned lesson in the session.

11. The computer program product of 10, the operations further comprising:
authenticating, as a part of the analyzing, the pattern of the action, wherein the pattern of the action comprises a speech sample being output by the IA into the session;
inputting the speech sample in a pre-trained speech analysis model, wherein the speech analysis model is pre-trained using a repository of speech snippets from a set of human instructors, the set of human instructors comprising the valid human instructor; and
outputting from the speech analysis model a determination that the speech sample fails to correspond to the valid human instructor within a specified tolerance, wherein the determination forms a basis for the detecting.

12. The computer program product of 10, the operations further comprising:
authenticating, as a part of the analyzing, the pattern of the action, wherein the pattern of the action comprises a sample of a behavior being produced by the IA in the session;
inputting the sample of the behavior in a pre-trained behavior analysis model, wherein the behavior analysis model is pre-trained using a repository of behavior snippets from a set of human instructors, the set of human instructors comprising the valid human instructor; and
outputting from the behavior analysis model a determination that the sample of the behavior fails to correspond to the valid human instructor within a specified tolerance, wherein the determination forms a basis for the detecting.

13. The computer program product of 10, the operations further comprising:
authenticating, as a part of the analyzing, the pattern of the action, wherein the pattern of the action comprises a sample of an interaction between the IA and another avatar in the session;
inputting the sample of the interaction in a pre-trained behavior analysis model, wherein the behavior analysis model is pre-trained using a repository of interaction snippets from a set of human instructors, the set of human instructors comprising the valid human instructor; and
outputting from the behavior analysis model a determination that the sample of the interaction fails to correspond to the valid human instructor within a specified tolerance, wherein the determination forms a basis for the detecting.

14. The computer program product of 10, the operations further comprising:
authenticating, as a part of the analyzing, the pattern of the action, wherein the pattern of the action comprises a sample of a sequence of presentations by the IA in the session;
inputting the sample of the sequence of presentations in a pre-trained sequence analysis model, wherein the sequence analysis model is pre-trained using a repository of presentation sequence snippets from a set of human instructors, the set of human instructors comprising the valid human instructor; and
outputting from the sequence analysis model a determination that the sample of the sequence of presentations fails to correspond to the valid human instructor within a specified tolerance, wherein the determination forms a basis for the detecting.

15. The computer program product of 10, the operations further comprising:
authenticating, as a part of the analyzing, the pattern of the action, wherein the pattern of the action comprises a sample of a timing alignment of a sequence of presentations with the content presented by the IA in the session;
inputting the sample of the timing alignment in a pre-trained sequence analysis model, wherein the sequence analysis model is pre-trained using a repository of presentation sequence snippets from a set of human instructors, the set of human instructors comprising the valid human instructor; and
outputting from the sequence analysis model a determination that the sample of the timing alignment fails to correspond to the valid human instructor within a specified tolerance, wherein the determination forms a basis for the detecting.

16. The computer program product of 10, the operations further comprising:
authenticating, as a part of the analyzing, the sample of the content, wherein the sample of the content comprises a teaching material being output by the IA into the session;
determining that the teaching material fails to correspond to a pre-authenticated content within a specified tolerance; and
outputting from the speech analysis model a determination that the sample of the content fails to correspond to the valid human instructor, wherein the determination forms a basis for the detecting.

17. The computer program product of 10, the operations further comprising:
authenticating, as a part of the analyzing, the sample of the content, wherein the sample of the content comprises a teaching material being output by the IA into the session;
determining that a source of the teaching material fails to correspond to a pre-authenticated source of a pre-authenticated content; and
outputting a determination that the sample of the content fails to correspond to the valid human instructor, wherein the determination forms a basis for the detecting.

18. The computer program product of claim 10, wherein the stored program instructions are stored in a computer readable storage device in a data processing system, and wherein the stored program instructions are transferred over a network from a remote data processing system.

19. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

20. A computer system comprising a processor and one or more computer readable storage media, and program instructions collectively stored on the one or more computer readable storage media, the program instructions executable by the processor to cause the processor to perform operations comprising:
activating at least one instructor avatar (IA) in a virtual reality (VR) education session (session);
capturing, from the session, a sampling, the sampling being one of (i) a pattern of an action of the IA in the session, and (ii) a sample of content being presented in the session;
analyzing whether the sampling from the session corresponds to a valid human instructor assigned to the session;
detecting, responsive to the analyzing, that the IA has been compromised in the session;
ejecting the IA from the session while maintaining a continuity of the session; and
replacing, in the session, the IA with a replacement IA such that the replacement IA continues a planned lesson in the session.
